(19) United States
(12) Patent Application Publication
(10) Pub. No.: US 2011/0119805 A1
(43) Pub. Date: May 26, 2011

(54) CHARM HAT

(76) Inventors: Michael David Slarve, Lebanon, TN (US); Karrie Lea Smith, Lebanon, TN (US)

(21) Appl. No.: 12/623,791

(22) Filed: Nov. 23, 2009

(51) Int. Cl. A42B 1/24; B23P 17/04

(52) U.S. Cl. 2/209.13; 29/428

(57) ABSTRACT

A charm hat 10 comprising an attachment 30 for attaching a charm 70 with the charm hat 10 at specific locations; an exterior covering 60; and the charm attached with the attachment for attaching the charm; wherein the exterior covering includes a material woven loose enough for the charm to be attached with the means for attaching. An interior lining 20 may be attached with the exterior covering such that the attachment 30 for attaching a charm 70 may be attached with the interior lining 20. Also included is a method for attaching charms 70 with a charm hat 10 comprising the steps of reaching through the weave of an exterior covering 60 of the charm hat to extract an attachment ring 50 attached to an attachment line; attaching the charm with the attachment ring; and reinserting the attachment ring between the exterior covering and an interior lining 20.

### FIELD OF INVENTION

The present invention relates to apparel for wearing charms on a hat. More specifically, a CHARM HAT providing a means for attaching charms in specific locations with a knit hat.

### BACKGROUND OF INVENTION

Consumers desire fashions. They like the latest in apparel. They also like to wear decorative apparel and ornaments that identifies with the consumers preferences and be personalized by the consumer. Decorative ornaments and apparel tell the person's story, a personal expression, and it also creates a collection that tells their story. The consumers like to customize their own stories in these collections as well as express their personal style and expressions of love and affection. Charms such as travel, hobbies, holidays, nature, symbols, love, Victorian, nostalgic, personalized, religious, school, message, sports, animals, ladybug, etc. have been used in the past by people to tell their stories. In the past consumers typically used bracelets and necklaces to display these decorative ornaments.

In the garment and jewelry field, a hat is needed to provide a means for attaching charms attractively to a knit hat and a hat is needed to provide strength and improve function for attractively displaying charms on head gear.

### BRIEF DESCRIPTION OF THE DRAWINGS

These and other features, aspects, and advantages of the invention will become better understood with regard to the following description, appended claims, and accompanying drawings where:

FIG. 1 is a side view of the charm hat depicting one embodiment;

FIG. 2 is an exploded view of the charm hat depicting one embodiment with illustrating the underlining with stitching and loops for attaching charms attached with the exterior covering;

FIG. 3 is a side view of the charm hat depicting one embodiment with a cut away illustrating the underlining with stitching and rings or loops for attaching charms;

FIG. 4A is an enlarged view of a portion of the charm hat depicting one embodiment illustrating the interior lining with attaching line and ring for attaching;

FIG. 4B is an enlarged view of a portion of the charm hat depicting one embodiment illustrating the interior lining with thread stitching and loops for attaching;

FIG. 4C is an enlarged view of a portion of the charm hat depicting one embodiment illustrating the interior lining with attaching ring for attaching stitched with interior lining;

FIG. 4D is an enlarged view of a portion of the charm hat depicting one embodiment illustrating the interior lining with the attaching ring mechanically attached with the interior lining.

### SUMMARY

A hat and method of using the hat is provided that includes a means for attaching charms attractively and in specific locations with a knit hat and a hat is provided for strength, and improved function by attractively displaying charms on head gear.

One of several embodiments include a charm hat comprising an interior lining; an attachment for attaching a charm with the interior lining; an exterior covering attached with the interior lining; and the charm attached with the attachment for attaching the charm with the interior lining; wherein the exterior covering includes a material woven loose enough for the charm to be attached with the means for attaching.

Another embodiment includes a method for attaching charms with a charm hat comprising the steps of reaching through the weave of an exterior covering of the charm hat to extract an attachment ring attached to an attachment line; attaching the charm with the attachment ring; and reinserting the attachment ring between the exterior covering and an interior lining.

### DETAILED DESCRIPTION OF THE INVENTION

The present invention relates to apparel for wearing charms on a hat. More specifically, a charm hat provides a means for attaching charms attractively and in specific locations with a knit hat in a way that increases strength and improves function. The following description is presented to enable one of ordinary skill in the art to make and use the invention and to incorporate it in the context of particular applications. Various modifications, as well as a variety of uses in different applications will be readily apparent to those skilled in the art, and the general principles defined herein may be applied to a wide range of embodiments. Thus, the present invention is not intended to be limited to the embodiments presented, but is to be accorded the widest scope consistent with the principles and novel features disclosed herein.

Overview of the Invention:

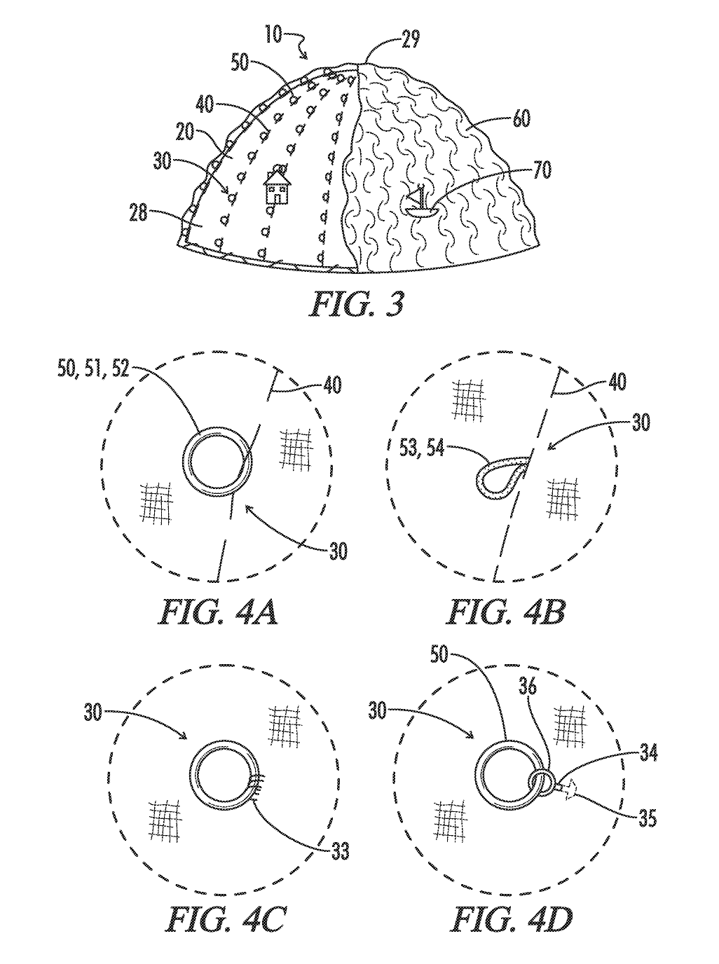

As depicted in FIG. 3, a charm hat 10 provides a means for attaching 30 charms 70 attractively and in specific locations with a knit hat 60 in a way that increases strength and improves function. The charm hat 10 comprises an interior lining 20; an attachment means 30; an exterior covering 60 attached with the interior lining 20; and a charm 70 attachable with the charm hat 10. The charm hat 10 allows a person to wear charms 70 attractively and securely with a hat such as a posh knit hat without the concern of losing expensive charm jewelry.

Design Specifications:

As illustrated in FIGS. 2, 3 and 4A through 4D, the primary function of the interior lining 20 is to provide a material for securely attaching charms 70. The interior lining 20 has a lower portion 28 and an apex 29. The interior lining 20 for the charm hat 10 may be made from any suitable material or fabric. Normally, the interior lining 20 is a different material than the material for an exterior covering 60 used with the charm hat 10. The material or the interior lining 20 may include but is not limited to synthetic, and natural material. It may be woven as one piece without seams or fabric stitched together. With certain embodiments the interior lining 20 may be omitted and the attachment means 30 may be attached with the exterior covering 60. When the interior lining 20 is omitted, the exterior covering 60 may be similar to a knit or crocheted hat.

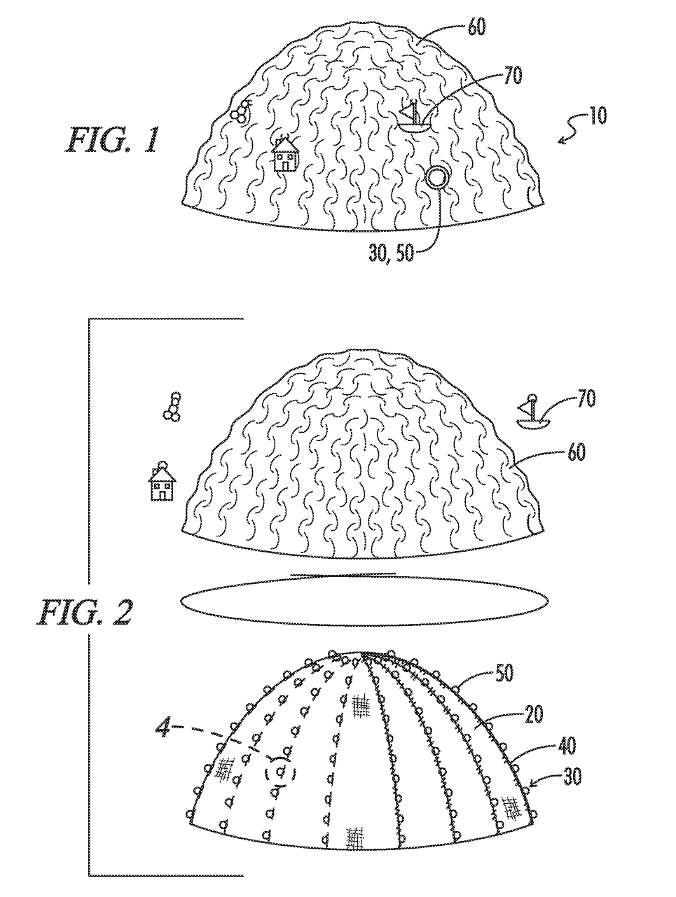

The means for attaching charms 30 with the interior lining 20 for the charm hat 10 may be a one or more attachment lines 40 that extend from the lower portion 28 of the interior lining 20 vertically to an apex 29 of the interior lining 20. The attachment line 40 may include but is not limited to a thread, a nylon thread, a metallic thread, or a fine metallic thread. The attachment line 40 may be woven into the interior lining 20 or the attachment line 40 may be attached with stitches, adhesive, or other means of attaching with the exterior of the interior lining 20. An at least one attachment ring 50 may be attached with the attachment line 40. The attachment line 40 may go from a lower portion 29 of the interior lining 20 to the apex 29 of the interior lining 20; the attachment line 40 may go from an approximately lower portion 28 of the interior lining 20 through the apex 28 of the interior lining 20 and then vertically downward to the approximately lower portion 29 of the interior lining 20 on the opposing side of the interior lining 20; or the attachment line 40 may be a short vertical line or thread attached with the interior lining 20 extending only a short distance or a portion of the distance between the lower portion 29 of the interior lining 20 and the apex 28 of the interior lining 20. The attachment ring 50 may include but is not limited to metallic attachment rings 51, silver and 14 ct. gold attachment rings 52, thread in the shape of a loop 53, and metallic thread or nylon thread 54 in the shape of a loop. The means for attaching a charm 30 may include a thread with loops created with knots or other means disposed along the length of the thread for attaching the at least one charms. There is also an additional embodiment wherein a single or individual means of attaching 30 a charm 70 is available. This includes a metallic ring 51 stitched 33 with the inner lining 20 as shown in FIG. 4C such that the charm 70 may be attached with the charm hat 10. The charm hat 10 means for attaching 30 the charms 70 may include at least one attachment ring 50 attached directly with the interior lining 20. The attachment ring 50 may be stitched 33 with the interior lining 20 or the attachment ring 50 may have a pin 34 attached with the attachment ring 50 wherein the pin 34 is inserted through the interior lining 20 and a locking backing plate 35 attached with the pin 34 such that the pin 34 and the locking backing plate 35 secure the attachment ring 50 with the interior lining 20. A swivel 36 may be used such that the attachment ring 50 may have freedom to rotate in relation to the pin 34. In yet another embodiment of the charm hat 10 wherein the interior lining is omitted as shown in FIG. 1, the attachment means 30 may be attached directly with the exterior covering 60. With omitted interior lining embodiments, an attachment means 30 or a ring 50 may be attached with the exterior covering 60 disposed at specific locations for attaching charms 70. The ring or loop attachment 50 with the exterior covering 60 may include stitching the loop or ring 50 with the fabric of the exterior covering 60 in one embodiment. In still another omitted interior lining embodiment, an attachment line or thread may extend from the lower portion of the exterior covering 60 toward the apex of the exterior covering 60 wherein the attachment line may be woven with the knit material or stitched to the material with the ring or loop 50 attached with the attachment line similar to the attachment means 30 employed with the interior lining application.

As depicted in FIGS. 1 through 4D, the exterior covering 60 may be attached with the interior lining 20. The exterior covering 60 may be a loosely woven, knit, or crocheted yarn or material such that a charm 70 may be attached with the attachment means 30. Typically, the means for attaching the charm 30 is disposed between the interior lining 20 and the exterior covering 60. The loose knit or weave of the yarn or material allows access to the attachment means such that the charm 70 may be securely attached to the charm hat 10. When the means for attaching a charm 30 is a metallic ring 51 or a thread loop 53, the metallic ring 51 or the thread loop 53 may be extracted through the loose weave of the exterior covering 60 such that the charm 70 may be attached with the metallic ring 51 and then the means for attaching the charm 30 or attachment ring 50 or thread loop 53 may be reinserted through the loose weave of the exterior covering 60 with the charm 70 remaining on the exterior of the exterior covering 60 such that the charm 70 remains visible for people to view. In addition, the attachment means ring 50 may remain on the exterior of the exterior covering 60. The ring 50 may include a 14 ct. gold ring or a silver ring wherein it may be desirable for the ring 52 to remain visible on the exterior along with the charm 70 for added appeal and fashion. As previously mentioned, another embodiment may include the exterior covering 60 without the interior lining. Wherein this embodiment may comprise the exterior covering 60 with the attachment means 30 attached with the exterior covering 60.

The charm 70, or the at least one charm, or decorative jewelry is attachable with the means for attaching the charm 30 with the interior lining 20 or with the exterior covering 60. The charm 70 may be any decorative jewelry that would be desirable to be worn on a head with a hat similar to charms currently worn with a necklace or with a bracelet.

The color of the charm hat 10 may be any color desired.

The method for attaching the charms:

The invention also includes a method for attaching and removing charms with a charm hat. The method comprises the steps of reaching through the weave of an exterior covering of the charm hat to extract an attachment ring attached to an attachment line; attaching the charm with the attachment ring; and reinserting the attachment ring between the exterior covering and an interior lining. Another embodiment may include the steps of reaching through the weave of an exterior covering of the charm hat to extract an attachment ring attached to an attachment line; attaching the charm with the attachment ring; and allowing the attachment ring to remain on the exterior of the exterior covering such that the charm and the attachment ring remain visible on the exterior covering of the charm hat. Yet another embodiment may include the steps of attaching the charm with a ring or loop disposed in specific locations attached to the exterior portion of the exterior covering.

What is claimed is:

1. A charm hat comprising:
an interior lining;
at least one attachment line attached with the interior lining, with the at least one attachment line extending from a lower portion of the interior lining vertically to an apex of the charm hat;
at least one attachment ring attached to the attachment line;
an exterior covering attached with the interior lining; and
at least one charm attachable with the at least one ring;
wherein the exterior covering includes a loose woven material such that the at least one charm may be attached with the attachment ring disposed between the exterior covering and the interior lining.

2. The charm hat of claim 1 wherein:
the interior lining comprises a different material than the exterior covering;
the at least one attachment line comprises a fine metallic thread;
the at least one attachment ring comprises metallic, such that the metallic attachment ring with the fine metallic thread securely attaches the at least one charm with the charm hat; and
the exterior covering comprises a loosely knit yarn allowing the attachment ring to be pulled through the exterior covering such that the at least one charm may be attached with the attachment ring and then the attachment ring reinserted between the exterior covering and interior liner such that the charm is visible on the exterior covering of the charm hat.

3. The charm hat of claim 1 wherein:
the interior lining is a cotten material;
the at least one attachment line comprises a thread attachment line woven in and out through the interior lining and the thread attachment line extends from the lower portion of the interior liner up vertically through the apex and down an opposing side to the lower portion of the interior lining;
the at least one attachment ring comprises a thread loop such that the thread attachment line with the thread loop attachment ring securely attaches the at least one charm with the charm hat; and
the exterior covering comprises a knit yarn material for allowing the at least one charm to be attached with the attachment ring such that the at least one charm is visible on the exterior covering of the charm hat.

4. The charm hat of claim 1 wherein:
the interior lining comprises a synthetic material;
the at least one attachment line comprises a nylon thread wherein the nylon thread attachment line attaches with the exterior of the interior lining and the nylon thread attachment line extends from the lower portion of the interior liner up vertically to the apex;
the at least one attachment ring comprises a nylon thread loop such that the nylon thread attachment line with the nylon thread loop attachment ring securely attaches the at least one charm with the charm hat; and
the exterior covering comprises a loosely crocheted material allowing the at least one charm to be attached with the nylon thread loop attachment ring such that the at least one charm is visible on the exterior covering of the charm hat.

5. The charm hat of claim 1 wherein:
the interior lining comprises a polyester material;
the at least one attachment ring comprises 14 ct. gold rings attached with the attachment line to hold the at least one charm securely; and
the exterior covering comprises a loosely weaved crocheted yarn such that the 14 ct. gold ring may be pulled through the yarn to attach the at least one charm to the 14 ct. gold ring and then the 14 ct. gold ring reinserted between the exterior covering and the interior lining.

6. A charm hat comprising:
a means for attaching a charm disposed at specific locations on the charm hat;
an exterior covering; and
at least one charm attached with the means for attaching the charm with the charm hat;
wherein the exterior covering includes a loosely woven material.

7. The charm hat of claim 6 wherein the means for attaching extend from a lower portion of the charm hat vertically to an apex of the hat.

8. The charm hat of claim 6 further comprising an interior lining; wherein the means for attaching comprises an attachment line woven together with the interior liner with a ring attached with the attachment line such that the ring may be disposed on an exterior of the interior liner for attaching the charm to the ring.

9. The charm hat of claim 6 further comprising an interior lining; wherein the means for attaching comprises a ring stitched together with the interior liner such that the ring may be disposed on an exterior of the interior liner for attaching the charm to the ring.

10. The charm hat of claim 6 wherein the means for attaching comprises a ring attached with the interior lining with a pin inserted through the interior lining and secured with the interior lining with a locking backing plate such that the ring is disposed on the exterior of the interior liner for attaching the charm to the ring.

11. The charm hat of claim 6 wherein the means for attaching comprises a ring stitched together with the exterior covering such that the ring comprises a 14 ct. gold ring and the ring may be disposed on the exterior of the exterior covering for attaching a charm to the ring.

12. The charm hat of claim 6 wherein the ring may be disposed on the exterior of the exterior covering for attaching the charm to the ring.

13. A method for attaching charms with a charm hat of claim 1 comprising the steps of:
reaching through the weave of an exterior covering of the charm hat to extract an attachment ring attached to an attachment line;
attaching the charm with the attachment ring; and
reinserting the attachment ring between the exterior covering and an interior lining.
